(19) United States
(12) Patent Application Publication
(10) Pub. No.: US 2026/0104376 A1
(43) Pub. Date: Apr. 16, 2026

(54) Sample Carrier Device for Measuring Instruments for the Thermal Sample Analysis, Measuring Instrument

(71) Applicant: NETZSCH-Gerätebau GmbH, Selb (DE)

(72) Inventors: Rebekka Taubmann, Selb (DE); Reinhard Gschwendtner, Marktredwitz (DE); Stefan Lauterbach, Döhlau (DE); Stefan Timm, Hof (DE); Markus Hollering, Wunsiedel (DE)

(21) Appl. No.: 19/352,971

(22) Filed: Oct. 8, 2025

(30) Foreign Application Priority Data
Oct. 10, 2024 (DE) 10 2024 129 235.0

(51) Int. Cl. G01N 25/20

(52) U.S. Cl. CPC G01N 25/20

(57) ABSTRACT

A sample carrier device for measuring instruments for the thermal sample analysis. This sample carrier device thereby includes a main carrier structure, a reference unit with a first thermocouple means and a sample carrier unit with a second thermocouple means, wherein the main carrier structure is designed to keep the reference unit as well as the sample carrier unit spatially separated from one another. In addition, a defined heat flow element is arranged between reference unit and sample carrier unit. In addition, a measuring instrument for the thermal sample analysis is presented.

### TECHNICAL FIELD

The present invention relates to a sample carrier device for measuring instruments for the thermal sample analysis as well as a measuring instrument for the thermal sample analysis.

### BACKGROUND

Instruments for the thermal sample analysis are already known and available on the market in a variety of designs. So that further areas of application can be opened up for this technology, there is currently not only a need for integrating more functions into a respective instrument unit but to simultaneously create a more compact structure thereby, so that mobile uses, for instance, can also be made possible in the future.

In some cases, current instruments have dimensions, which could be perceived as being unwieldy and as being inhibiting for new fields of application. With regard to the possible analysis techniques, current instruments also have mostly only a certain selection, so that further instruments would need to accordingly be procured for the provision of further analysis techniques.

Instruments are thus known, which are suitable either exclusively for the differential thermal analysis (DTA) or for the differential scanning calorimetry (DSC), respectively, or which are suitable for the thermogravimetry (TGA=thermogravimetric analysis). The TGA serves for the temperature-or time-dependent analysis of physical processes and chemical reactions, which are associated with changes in mass.

The differences thereby often lie in the respective handling of respective samples. In particular in the case of the DTA or in the case of the DSC, respectively, a more complex construction is required because, for example, instruments are generally equipped for this purpose with two sample crucibles, wherein the material to be analyzed is stored in the one crucible and the reference material is stored in the other crucible. Instruments for the TGA, in contrast, generally only require one crucible for the material to be analyzed. A scale, which is integrated in the measuring instrument, and which detects the changes in mass of the sample, and the temperature measurement on the sample are essential for the TGA.

In the case of the setup for DTA or the DSC, respectively, the two crucibles are then either heated up or cooled down in a targeted manner and under the same conditions, if possible, wherein both crucibles are dimensioned with respect to their thermal behavior in order to determine differences in the thermal behavior of the two materials thereby.

Methods of the simultaneous thermal analysis (STA) are also known, in the case of which the methods DTA or DSC, respectively, and TGA, are combined.

For future instruments, it would be desirable to provide a simpler setup, which can furthermore also provide for more extensive analysis methods.

### SUMMARY

In light of the foregoing, the present invention is based on the object of providing a sample carrier device for measuring instruments for the thermal sample analysis as well as a measuring instrument for the thermal sample analysis, which at least partly overcome the above-mentioned disadvantages.

This object is solved by means of a sample carrier device for measuring instruments, as well as by means of a measuring instrument for the thermal sample analysis with the features mentioned in the claims.

Accordingly, a sample carrier device for measuring instruments for the thermal sample analysis is provided, which comprises a main carrier structure, a reference unit with a first thermocouple means and a sample carrier unit with a second thermocouple means, wherein the main carrier structure is designed to keep the reference unit as well as the sample carrier unit spatially separated from one another. In addition, a defined heat flow element is arranged between the reference unit and the sample carrier unit.

A measuring instrument for the thermal sample analysis is furthermore provided, which comprises a sample carrier device according to the invention as well as a weight measuring means for capturing a sample mass of a sample to be analyzed.

An idea on which the invention is based lies in the provision of a compact sample carrier device, which can be comfortably provided in measuring instruments for the thermal sample analysis with spatially limited options, but without having to accept functionality losses.

In spite of a compact building code, provided measurements in terms of a differential scanning calorimetry (DSC) can in particular be carried out by means of the presented invention by means of a simple reference unit, which does not carry a reference sample, because required calibration steps can be performed easily and in a user-friendly manner prior to a first sample analysis by means of the provided defined heat flow element.

Deviating from classic definitions of the DSC method, there is no mention of a “defined heat flow path” in a more recent basic standard relating to the methods DTA (DTA=differential thermal analysis) and DSC (DIN 51007:2019-04) but rather of a clear separation between differential thermal analysis (DTA) for measuring the temperature difference and differential scanning calorimetry (DSC), which additionally provides for the measurement of the heat flow difference between sample and reference.

Ultimately, what is important is being able to make the calibration required for a measurement of the heat flow difference. The provided defined heat flow element can meet this requirement in this respect and can be used in an advantageous manner for these purposes, without requiring a complex construction with a reference sample in a further sample vessel (sample crucible) thereby.

The sample carrier device according to the invention for measuring instruments for the thermal sample analysis can be used in an advantageous manner in this respect for measuring a temperature difference and optionally a heat flow between a sample and a reference, wherein the reference is invariable and can be connected firmly at least temporarily to the respective measuring instrument via the sample carrier device.

At the same time, the inventive sample carrier device, in the case of a corresponding arrangement in a measuring instrument for the thermal sample analysis, is designed to provide for a measurement of a respective temperature on a sample, which is arranged, for instance, in a container in the sample carrier unit.

The sample carrier device has a number of components, which is manageable for the desired functionality, so that it can be accommodated in a space-saving manner in a measuring instrument for the thermal sample analysis. In this respect, the sample carrier device can be used, for instance, in a measuring instrument for the thermal sample analysis, which surrounds said sample carrier device. In this respect, it can be integrated in a space-saving manner in a heating and cooling means with a small interior space of a measuring instrument for the thermal sample analysis.

The inventive sample carrier device for measuring instruments for the thermal sample analysis is additionally designed to be used in an advantageous manner when it comes to calculating a heat flow from the temperature difference between the sample and the reference unit with the help of a calibration.

In connection with the presented invention, the term “spatially” is to be understood to be based on three dimensions. In other words, the reference unit and sample carrier unit are provided without direct contact to one another. Only the arranged heat flow element connects the two components in such a way that a heat flow can flow between the components here.

To the extent that they can be transferred, the above-mentioned advantages also apply for the presented inventive measuring instrument for the thermal sample analysis.

According to an exemplary embodiment of the sample carrier device, it is provided that the defined heat flow element is selected from: metal wire, copper wire, platinum wire, platinum alloy wire, nichrome wire, nickel alloy wire, metal sheet, copper sheet, platinum sheet, platinum alloy sheet, nichrome sheet, nickel alloy sheet, metal rod, copper rod, platinum rod, platinum alloy rod, nichrome rod, nickel alloy rod.

Space-saving concepts can thus be realized particularly easily and in an advantageous manner. In addition, the selected materials are well known, so that desired calibration steps can be performed easily and in an uncomplicated manner.

According to a further development of the sample carrier device, it is provided that the main carrier structure is designed to hold the reference unit below the sample carrier unit.

A resulting total circumference can thus have a defined maximum size because the two components are provided one on top of the other, so that space-saving concepts can be realized, for instance by means of an identical selection of the respective circumferences of the components.

According to a further development of the sample carrier device, it is provided that the main carrier structure comprises at least one first holding element, which is designed to reversibly receive the reference unit as well as the sample carrier unit. Due to the fact that the number of required components can thus be reduced further, space-saving concepts can be realized in a particularly advantageous manner.

According to an embodiment example of the sample carrier device, it is provided that the main carrier structure comprises a second holding element, which is designed to receive respective connecting line sections of the first and second thermocouple means and to hold the first holding element

A modular setup in the presented manner has the advantage that particularly user-friendly concepts can thus be realized in order to simplify maintenance work or exchange processes of held components, for instance.

According to an embodiment example of the sample carrier device, it is provided that the second holding element comprises a first end region, which is designed to be received by the first holding element, and comprises a second end region, lying opposite the first end region, which is designed to receive a plug contact unit of the sample carrier device for connecting the respective connecting line sections of the first and second thermocouple means to a measuring instrument.

The sample carrier device can be inserted in a user-friendly manner and in a simple manner into a measuring instrument in this way, so that, for instance, an exchangeability with another sample carrier device or upcoming maintenance work in connection with exchange processes of carried components or structures can be carried out particularly easily and in an advantageous manner.

According to a further development of the sample carrier device, it is provided that the sample carrier unit comprises holding means for holding respective sample containers, which are designed to be capable of being set in a flexible manner, so that respective sample containers of a different size and of different materials can each be received individually by the sample carrier unit in a reversible manner.

In this respect, the sample carrier device according to the invention is designed to receive different containers in order to receive respective samples. The respective containers can thereby be designed in the way they are usually used in the thermal analysis. In this respect, the containers can, for instance, be different crucibles, which differ in their size, for example with respect to an average diameter.

In general, different crucibles with different shapes can also be received because the holding means can be formed to be sufficiently flexible for these purposes. The containers can also be made of different materials because the holding means can be formed to be sufficiently flexible for these purposes. The container is usually placed onto the sample carrier device prior to the measurement and is removed again after the measurement.

According to an embodiment example of the sample carrier device, it is provided that the first holding means is made of aluminum oxide (Al₂O₃).

Due to the fact that this is a material with poor thermal conductivity, the provided heat flow path can be used without any problems in the provided manner by means of the defined heat flow element. Due to the fact that it is also a highly heat-resistant material, such a holding means can be used particularly well in regions of a measuring instrument, which is provided for heating up the respective samples.

According to an embodiment example of the sample carrier device, it is provided that the reference unit and the sample carrier unit are arranged one on top of the other without direct contact and each have at least a diameter, which essentially corresponds to at least twice the diameter of the second holding element.

Space-saving concepts can thus be realized in an advantageous manner. Different diameters are thus conceivable, wherein each component can also have a specific diameter. However, the minimum limit of twice the diameter must not be fallen below in each case thereby. This has the advantage that an optimal arrangement in specific measuring instruments can thus be ensured at any time.

According to an exemplary embodiment of the sample carrier device, it is provided that the sample carrier unit can be reversibly fastened to the first holding element by means of at least one first plug connection.

Exchange processes of sample carrier units can thus be made comfortably and within a user-friendly time interval.

According to an embodiment example of the sample carrier device, it is provided that the reference unit can be reversibly fastened to the first holding element by means of at least one second plug connection.

Exchange processes of reference units can thus be made comfortably and within a user-friendly time interval.

According to an embodiment example of the sample carrier device, it is provided that the first holding element can be reversibly fastened to the second holding element by means of at least one plug connection.

An even better modular setup can be promoted in this way, so that flexible and user-friendly concepts can be provided, for example, for maintenance work or exchange processes of components of the sample carrier device.

According to an embodiment example of the sample carrier device, it is provided that the at least one plug connection between first and second holding element essentially has a conical shape.

This shape of a plug connection offers the advantage of providing a user-friendly reversibility on the one hand and of ensuring a reliable strength even in response to high temperature fluctuations on the other hand, so that a particularly reliable and stable sample carrier device results.

According to an embodiment example of the sample carrier device, it is provided that the sample carrier unit is essentially made of a metal film, wherein the metal is selected from: platinum, platinum alloy, nichrome, nickel alloy, steel and similar alloys, and wherein a thickness of the metal film between 0.02 to 3 mm, preferably between 0.03 and 2 mm, preferably between 0.05 to 1 mm is provided.

Space-saving concepts of the sample carrier device can thus be provided in an even more advantageous manner because the sample carrier unit thus requires only a very small room volume in order to be functionally available for the intended purposes.

According to an embodiment example of the sample carrier device, it is provided that respective plug connections are reinforced with at least one ceramic adhesive.

In this way, the sample carrier device can be used for applications, which require a particularly high stability. A respectively used ceramic adhesive can, for example, be selected and made in such a way that temperature resistances of up to 1,700° C. can be reached. A reversibility can be limited thereby but wherein releasing processes can nonetheless be effected with a certain use of force, if necessary. A new adhesion can subsequently take place.

According to an embodiment example of the measuring instrument, it is provided that the measuring instrument is provided without a weight measuring means for capturing a sample mass of the sample to be analyzed.

### BRIEF DESCRIPTION OF THE DRAWINGS

The invention will be explained below with reference to the figures of the drawings, in which:

FIG. 1 shows a schematic side view of a sample carrier device for measuring instruments for the thermal sample analysis;

FIG. 2 shows a further schematic side view of an alternative sample carrier device for measuring instruments for the thermal sample analysis;

FIG. 3 shows a further schematic side view of a sample carrier device for measuring instruments for the thermal sample analysis;

FIG. 4 shows a schematic top view onto a sample carrier device for measuring instruments for the thermal sample analysis without sample carrier unit;

FIG. 5 shows a schematic illustration of a measuring instrument for the thermal sample analysis.

The same reference numerals in the figures identify identical or functionally identical components, unless otherwise specified.

### DETAILED DESCRIPTION

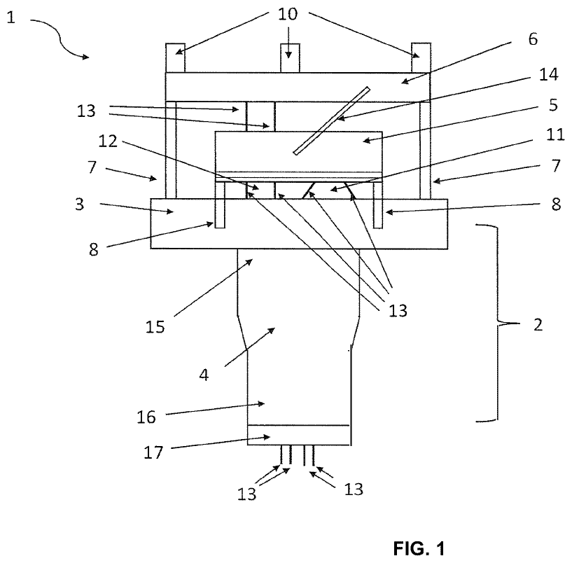

FIG. 1 shows a schematic side view of a sample carrier device 1 for measuring instruments for the thermal sample analysis.

The sample carrier device 1 is illustrated with a main carrier structure 2 thereby. The main carrier structure 2 comprises a first and a second holding element 3, 4. In the embodiment illustrated in FIG. 1, the second holding element 4 holds the first holding element by means of holding means, which are not illustrated in detail.

This can be, for example, a plugged connection or, for instance, a screw connection, by means of which the two holding means 3, 4 are reversibly connected to one another. In an embodiment variation, which is not illustrated in detail, it is conceivable that the two holding elements 3, 4 are provided essentially in one piece as unit.

In the shown schematic side view, the first holding element 3 has an essentially rectangular shape, wherein, based on the image plane, it is provided above the second holding element 4 and in each case spatially towers over the second holding element 4 on lateral regions. In the shown embodiment variation, the main carrier structure 2 is provided in an essentially rotationally symmetrical manner. The first holding element 3 has a portion, which is directed downwards (based on the image plane), which is suitable to establish a mechanical connection with the second holding element 4. This portion thereby has larger external dimensions than the holding element 4. It is thus possible, for example, that this portion of the holding element 3, which is directed downwards, receives the holding element 4 by means of insertion.

The holding element 4 is shown in a rod-shaped manner and essentially in a cylindrical shape thereby. Alternative shapes are conceivable in embodiment variations, which are not illustrated in detail. It is thus conceivable that an essentially identical shape results towards the bottom and that a rectangular shape or the like is provided instead of a cylindrical shape.

The first holding element 3 is designed to reversibly receive an illustrated reference unit 5 as well as an illustrated sample carrier unit 6 of the sample carrier device 1.

In the shown schematic side view, the reference unit 5 has an essentially rectangular shape, wherein, based on the image plane, it is provided below the sample carrier unit 6.

In the shown schematic side view, the sample carrier unit 6 likewise has an essentially rectangular shape, wherein, based on the image plane, it is provided above the reference unit 5.

The sample carrier unit 6 can be reversibly fastened to the first holding element 3 by means of two first plug connections 7. For this purpose, the first holding element 3 can have respective slots, into which the two first plug connections 7 can be inserted with an essentially accurate fit.

In embodiment variations, which are not illustrated in detail, the number of first plug connections can vary, wherein the number of slots in the first holding element 3 is to then be adapted accordingly. For example, three or four first plug connections 7 can also be provided, which are thereby located essentially at the same distance in an outer region of the sample carrier unit 6 and thereby likewise protrude downwards essentially at a right angle (based on the image plane).

These two first plug connections 7 are thereby provided on opposite lateral regions of the sample carrier unit 6 and protrude downwards essentially at a right angle from said sample carrier unit, wherein they are provided in the lower region so as to be inserted into the first holding element 3.

As illustrated, these two first plug connections 7 can be provided as separate components, which are firmly connected to the sample carrier unit 6. Alternatively, it is conceivable that the sample carrier unit 6 and the two first plug connections 7 are provided in one piece and thus represent a structural unit. In both variations, the sample carrier unit 6 and the two first plug connections 7 can be made of the same material and thereby essentially have an identical characteristic with regard to their thickness. It is conceivable, for example, that they are made of a metal film or a flexible metal plate.

In an embodiment variation, which is not illustrated in detail, it is conceivable that the two first plug connections 7 are provided so as to each be plugged through the first holding element 3, so that, based on the image plane, they protrude downwards out of the first holding element 3, wherein the protruding share of the respective first plug connections 7, which can also be referred to as tabs, is subsequently rotated or twisted, respectively, for example by 90° or more, for example 95°, 100° or 120 to 150° ore the like.

In addition, a small amount of ceramic adhesive or the like can be attached at this respective rotated or twisted point, respectively, in order to effect an additional stability. The amount can be selected, for example, so that a sufficient stability can be provided and it is nonetheless possible to effect a separation, which can be attained under the action of force, of the sample carrier unit 6, which is connected to the first holding element 3.

The reference unit is illustrated so as to be reversibly fastened to the first holding element 3 by means of two second plug connections 8. These second plug connections 8 thereby protrude downwards essentially at a right angle and are each provided on an outer side of the first holding element 3.

On this outer region of the first holding element 3, they protrude beyond a longitudinal center of the first holding element 3. Shares of these second plug connections 8 are in each case located on the opposite side, which is obscured in this side view, wherein they form a clamp-like structure together with the illustrated parts of the second plug connections 8, so that the second plug connections 8 are attached to the first holding element 3.

In an embodiment variation, which is not illustrated in detail, it is conceivable that the second plug connections 8 are each attached to the first holding element 3 as shown, wherein respective end regions of the respective shares protrude downwards (based on the image plane) beyond the first holding element 3.

The illustrated second plug connections 8 are additionally illustrated so as to be connected to one another, wherein a connecting region 9 has a same side length as the reference unit 5 and is provided below the latter.

In an embodiment variation, which is not illustrated in detail, it is conceivable that this connecting region 9, on which the second plug connections 8 are arranged in each case, is provided din one piece together with the reference unit 5 and the second plug connections 8. It is also conceivable that they are simply structures which are connected to one another, wherein at least the reference unit 5 is provided so as to made of a different material. It is conceivable in this respect that, together, the connecting region 9 and the second plug connections 8 represent a material unit of one material and the reference unit 5 accordingly of a different material, which differs at least with respect to its heat-conducting properties from the material of the material unit.

The reference unit 5 and the sample carrier unit 6 are illustrated so as to be spatially separated from one another, wherein the main carrier structure 2 is provided so as to be formed specifically for this purpose.

Based on the image plane, the sample carrier unit 6 has a total of three holding means 10 on the top, which are connected to a main body of the sample carrier unit 6. This connection can also be a material connection. In other words, the respective holding means 10 can also in each case be an integral part of the sample carrier unit 6. The holding means 10 in each case protrude upwards essentially at a right angle (based on the image plane) and are provided for holding respective sample containers, which are not illustrated in detail. The holding means 10 are thereby designed to be capable of being set in a flexible manner, so that respective sample containers of a different size, which are not illustrated in detail, and various materials can in each case be individually received in a reversible manner by the sample carrier unit 6. For example, sample containers, which contain a sample to be measured, with different sizes, in particular with respect to their respective average diameter, can thus be received by the sample carrier unit 6, wherein the holding means 10 then ensure a certain stability during this reception. For example, the holding means 10 can be provided so as to be bendable, so that they can be bent in the direction of respective walls of the received sample container in order to effect corresponding holding forces, by means of which the received sample container is held approximately in the center of the sample carrier unit 6.

In addition, the sample carrier device 1 for measuring instruments for the thermal sample analysis is illustrated with the reference unit 5 with a first thermocouple means 11 and the sample carrier unit 6 with a second thermocouple means 12. Of the first and second thermocouple means 11, 12, only respective thermocouple wires 13 can in each case be seen in FIG. 1. Respective corresponding thermocouples are obscured by the sample carrier unit 6 or by the reference unit 5, respectively, in this side view.

Temperatures can be measured on the sample carrier unit 6 and on the reference unit 5 by means of the respective thermocouple means 11, 12, when the inventive sample carrier device 1 is accordingly connected in a functional manner to a measuring instrument for the thermal sample analysis. The temperature difference between the two thermocouple means 11, 12 can also be captured by means of a corresponding evaluation electronics.

In addition, a defined heat flow element 14 is illustrated so as to be arranged between the reference unit 5 and the sample carrier unit 6. In particular in this side view illustrated in FIG. 1, this heat flow element 14 is thereby provided so as to be arranged on respective main bodies of the reference unit 5 and of the sample carrier unit 6. In particular, the heat flow element 14 is provided thereby so as to be firmly connected to the reference unit 5 and the sample carrier unit 6 in each case.

In other words, a connection is provided in each case, which is suitable to provide for a heat flow between the components. It is conceivable, for example, that the respective connections are connections, which can essentially be equated to a material connection between the respective components.

The main carrier structure 2 thereby comprises the second holding element 4, which is designed to receive respective connecting line sections, i.e., the thermocouple wires 13, of the first and second thermocouple means 11, 12 and to simultaneously hold the first holding element 3. In addition, the main carrier structure 2 is designed and illustrated to hold the reference unit 5 below the sample carrier unit 6, wherein respective connecting line sections, i.e., the thermocouple wires 13, are illustrated so as to be guided essentially in the center of the sample carrier device 1.

The second holding element 4 has a first end region 15, which is received by the first holding element 3, and additionally a second end region 16, which lies opposite the first end region 15 and which is designed to receive a plug contact unit 17 of the sample carrier device 1 for the connection of the respective connecting line sections, i.e., the thermocouple wires 13, of the first and second thermocouple means 11, 13, to a measuring instrument, which is not illustrated in detail. In the illustration of FIG. 1, these thermocouple wires 13 protrude downwards (based on the image plane). These are the same thermocouple wires 13, which are in each case partially illustrated between the sample carrier unit 6 and the first holding element 3.

It is likewise conceivable, however, that these ends are provided so as to be arranged in the plug contact unit 17 and can then be connected to connecting regions of a measuring instrument, which is not illustrated in detail, by means of a plug contact principle or the like.

In a further embodiment variation, which is not illustrated in detail, it is conceivable that the first and second holding element 3, 4 form a single material unit, i.e., as a component part, which has the respective functions of the first and second holding element 3, 4.

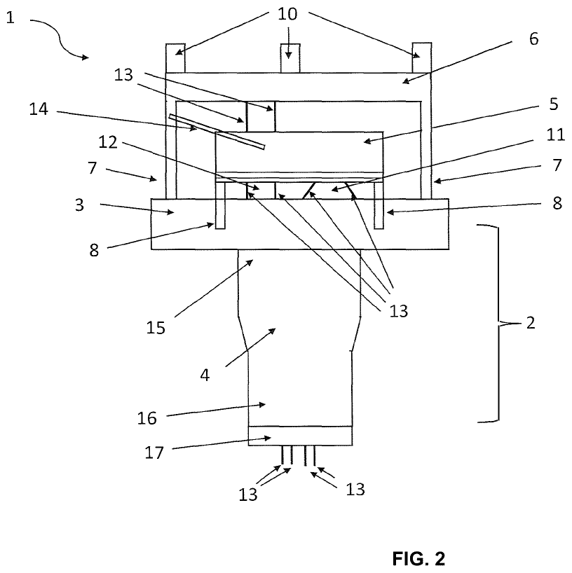

FIG. 2 shows a further schematic side view of an alternative sample carrier device 1 for measuring instruments for the thermal sample analysis.

This is essentially the same sample carrier device 1 for measuring instruments for the thermal sample analysis, as it is illustrated and described in FIG. 1. The same reference numerals are used here, so that they are not introduced anew at this point.

An essential difference between FIG. 2 and FIG. 1 is the localization of the defined heat flow element 14. This defined heat flow element 14 is likewise provided between the reference unit 5 and the sample carrier unit 6 in FIG. 2, but wherein a connecting point on the sample carrier unit 6 is provided via the first plug connection 7. The sample carrier unit 6 and the respective first plug connections 7 are provided as material unit in FIG. 2. In other words, it is a one-piece structural component, which is thus formed to be inherently heat-conducting. The sample carrier unit 6 with the corresponding respective first plug connections 7 can be formed, for example, as metal film or metal sheet, wherein the respective first plug connections 7 are bent away downwards based on the image plane. A connecting point of the defined heat flow element 14 thus lies on the sample carrier unit 6, wherein a heat-conducting path via one of the plug connections 7 is accordingly provided in FIG. 2.

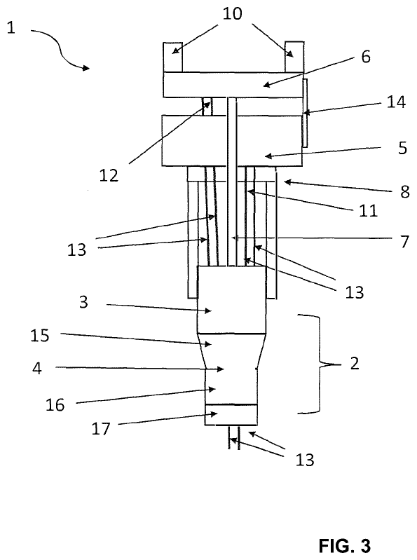

FIG. 3 shows a further schematic side view of a sample carrier device 1 for measuring instruments for the thermal sample analysis.

This is essentially the same sample carrier device 1 for measuring instruments for the thermal sample analysis as it is illustrated and described in FIG. 1. The same reference numerals are used here, so that they are not introduced anew at this point.

A side view, which is rotated by 90° with respect to the illustration of FIG. 1, is illustrated in FIG. 3. The respective second plug connections 8 are thereby illustrated so as to be attached to the first holding element 3, wherein respective end regions of the respective shares protrude downwards (based on the image plane) beyond the first holding element 3. In this respect, the respective second plug connections 8 are not only attached to the first holding element 3 but are rather provided so as to be clamped thereon, so that a secure hold of the reference unit 5 on the holding element 3 results.

The respective connecting line sections, i.e., the thermocouple wires 13, which project downwards beyond the plug contact unit 17, of the first and second thermocouple means 11, 12 in each case conceal a thermocouple wire 13, so that only two thermocouple wires 13 are illustrated at this point in the side view of FIG. 3.

Four thermocouple wires 13 are illustrated above the first holding element 3, wherein two thermocouple wires 13 are in each case provided for the respective thermocouple means 11, 12. In this respect, the thermocouple wires 13 of the respective thermocouple means 11, 12 are guided from the bottom to the top within the main carrier structure 2 and are distributed according to their function above the first holding element 3.

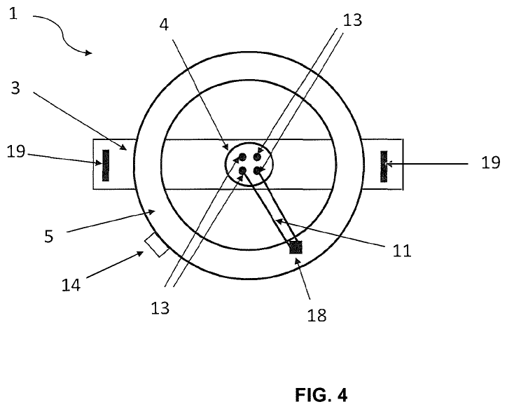

FIG. 4 shows a schematic top view onto a sample carrier device 1 for measuring instruments for the thermal sample analysis without sample carrier unit.

This can essentially be the same sample carrier device 1 for measuring instruments for the thermal sample analysis, as it is illustrated and described in FIG. 1. In this respect, the same reference numerals are used here, so that they are not introduced anew at this point.

The reference unit 5 is thereby illustrated as essentially round element, which has a free space in its center. The first holding element 3 is illustrated essentially with a rectangular shape, wherein the view into the second holding element 4 is cleared in the center of the first holding element 3. In this respect, the second holding element 4 is provided to be hollow on the inside, so that the thermocouple wires 13 of the respective thermocouple means 11, 12 can be guided in this hollow space.

The thermocouple means 11, which measures a temperature on the reference unit 5, is illustrated in FIG. 4, wherein a thermocouple 18 is analogously connected in direct contact to a surface section of the reference unit 5. The thermocouple 18 is thereby bordered by respective thermocouple wires 13 of the thermocouple means 11. These thermocouple wires 13 are thereby provided in direct contact with the thermocouple 18. The thermocouple 18 can have a spatial expansion in all directions of a few millimeters, for example in a range of 1 to 35 mm, preferably of 5 to 20 mm, preferably of 2 to 15 mm, preferably of 3 to 7 mm.

In one embodiment, for example, the thermocouple 18 can have a dimension, which goes beyond the dimension of a simple thermocouple bead, and which is thus suitable and designed to determine a temperature profile of up to a certain degree in a range between a sample to be measured and the reference unit 5.

In the application of the sample carrier device 1, a defined heat flow path exists in this respect between a sample to be measured, which is held on the sample carrier unit 5, for example, in that it is stored in a crucible or the like, and the reference unit 5. In this respect, the sample carrier unit 6 of the sample carrier device 1 is connected directly to the reference unit 5 and to a defined thermal resistor via a material in the solid state.

In this illustration, the sample carrier device 1 for measuring instruments for the thermal sample analysis is illustrated without sample carrier unit 6, so that there is a clear view onto the first and second holding element 3, 4. The sample carrier unit 6 would analogously connect without direct contact above the illustrated reference unit 5, wherein a connection is provided by means of the illustrated defined heat flow element 14.

In addition, respective insertion slot regions 19, into which the non-illustrated sample carrier unit 6 can be inserted, are illustrated in the first holding element 3 on respective lateral end regions. In this illustrated embodiment, these insertion slot regions 19 have an essentially rectangular shape.

In other embodiments, which are not illustrated in detail, however, it is conceivable that they have alternative shapes, wherein they are to be selected essentially according to a shape of the first plug connections 7 of the non-illustrated sample carrier unit 6, so that the plug connections 7 can accordingly be fastened at this point to the first holding element 3 with a fit, which is as accurate as possible.

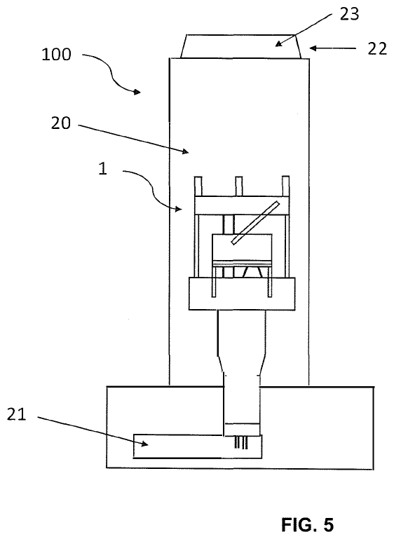

FIG. 5 shows a schematic illustration of a measuring instrument 100 for the thermal sample analysis. An inventive sample carrier device 1 for measuring instruments for the thermal sample analysis is illustrated thereby so as to be arranged in a heating and cooling means 20 of the measuring instrument 100.

This can essentially be the same sample carrier device 1 for measuring instruments for the thermal sample analysis, as it is illustrated and described in FIG. 1.

The sample carrier device 1 is thereby provided essentially in the center of the heating and cooling means 20 of the measuring instrument 100, wherein the sample carrier device 1 is illustrated so as to be functionally coupled to a connecting unit 21 of the measuring instrument 100 via the plug contact unit 17.

Respective thermocouple wires 13 of respective thermocouple means 11, 12 of the sample carrier device 1 are thereby in particular provided so as to be coupled to the measuring instrument 100, so that corresponding control and measuring processes can be effected via a control means of the measuring instrument 100, which is not illustrated in detail.

It is in particular possible that a weight measuring means, for example in the form of a scale, which is not illustrated in detail, is included in the measuring instrument 100, to which the sample carrier device 1 is connected via the plug contact unit 17.

This then provides for the measurement of the sample mass, also as a function of temperature and time, simultaneously to the capturing of the temperatures via the thermocouple means 11 and 12 as well as the temperature difference thereof. The heat flow can be calculated from the temperature difference by means of a suitable calibration.

Due to its space-saving structure and characteristic, the sample carrier device 1 can be arranged in a particularly advantageous manner in the measuring instrument 100 and can, for example, be maintained or even be exchanged easily. A sample to be measured in a corresponding sample container can also be easily inserted into or arranged on, respectively, the sample carrier device 1.

It is conceivable that the measuring instrument 100 has a lifting mechanism, which is not illustrated in detail, so that the sample carrier device 1 can be stored or functionally coupled, respectively, so as to be capable of being displaced upwards based on the image plane. A user can then subsequently carry out, for example, an exchange process or the like via an opening region 22 with cover element 23 of the measuring instrument 100. For example, components of the sample carrier device 1 can also be capable of being accessed easily in this way for the purpose of maintenance processes or exchange processes because the sample carrier device 1 has a correspondingly sleek design and the arrangement of the individual components is mounted particularly advantageously for these purposes.

For example, different thermocouple means 11, 12 can thus be provided in terms of a modular design principle, wherein individual components are then provided so as to be capable of being easily exchanged, without the measuring instrument 100 having to be disassembled in a complex manner into its individual parts for this purpose.

1. A sample carrier device for measuring instruments for the thermal sample analysis comprising a main carrier structure, a reference unit with a first thermocouple means and a sample carrier unit with a second thermocouple means, wherein the main carrier structure is designed to keep the reference unit as well as the sample carrier unit spatially separated from one another, wherein a defined heat flow element is arranged between reference unit and sample carrier unit.

2. The sample carrier device according to claim 1, wherein the defined heat flow element is selected from: metal wire, copper wire, platinum wire, platinum alloy wire, nichrome wire, nickel alloy wire, metal sheet, copper sheet, platinum sheet, platinum alloy sheet, nichrome sheet, nickel alloy sheet, metal rod, copper rod, platinum rod, platinum alloy rod, nichrome rod, nickel alloy rod.

3. The sample carrier device according to claim 2, wherein the main carrier structure is designed to hold the reference unit below the sample carrier unit.

4. The sample carrier device according to claim 1, wherein the main carrier structure comprises at least one first holding element, which is designed to reversibly receive the reference unit as well as the sample carrier unit.

5. The sample carrier device according to claim 1, wherein the main carrier structure comprises a second holding element, which is designed to receive respective connecting line sections of the first and second thermocouple means and to hold the first holding element.

6. The sample carrier device according to claim 5, wherein the second holding element comprises a first end region, which is designed to be received by the first holding element, and includes a second end region, lying opposite the first end region, which is designed to receive a plug contact unit of the sample carrier device for connecting the respective connecting line sections of the first and second thermocouple means to a measuring instrument.

7. The sample carrier device according to claim 1, wherein the sample carrier unit comprises holding means for holding respective sample containers, which are designed to be capable of being set in a flexible manner, so that respective sample containers of a different size and of different materials can each be received individually by the sample carrier unit in a reversible manner.

8. The sample carrier device according to claim 1, wherein the first holding means is made of aluminum oxide.

9. The sample carrier device according to claim 1, wherein the reference unit and the sample carrier unit are arranged one on top of the other without direct contact and each have at least a diameter, which essentially corresponds to at least twice the diameter of the second holding element.

10. The sample carrier device according to claim 4, wherein the sample carrier unit can be reversibly fastened to the first holding element by means of at least one first plug connection.

11. The sample carrier device according to claim 4, wherein the reference unit can be reversibly fastened to the first holding element by means of at least one second plug connection.

12. The sample carrier device according to claim 4, wherein the first holding element can be reversibly fastened to the second holding element by means of at least one plug connection.

13. The sample carrier device according to claim 12, wherein the at least one plug connection between first and second holding element essentially has a conical shape.

14. The sample carrier device according to claim 1, wherein the sample carrier unit is essentially made of a metal film, wherein the metal is selected from: platinum, platinum alloy, nichrome, nickel alloy, steel and similar alloys, and wherein a thickness of the metal film between 0.02 to 3 mm, preferably between 0.03 and 2 mm, preferably between 0.05 to 1 mm is provided.

15. The sample carrier device according to claim 4, wherein respective plug connections are reinforced with at least one ceramic adhesive.

16. A measuring instrument for the thermal sample analysis comprising a sample carrier device including a main carrier structure, a reference unit with a first thermocouple means and a sample carrier unit with a second thermocouple means, wherein the main carrier structure is designed to keep the reference unit as well as the sample carrier unit spatially separated from one another, wherein a defined heat flow element is arranged between reference unit and sample carrier unit, as well as a weight measuring means for capturing a sample mass of a sample to be analyzed.

17. The measuring instrument according to claim 16 without a weight measuring means for capturing a sample mass of a sample to be analyzed.

18. The sample carrier device according to claim 2, wherein the main carrier structure comprises at least one first holding element, which is designed to reversibly receive the reference unit as well as the sample carrier unit.

19. The sample carrier device according to claim 2, wherein the main carrier structure comprises a second holding element, which is designed to receive respective connecting line sections of the first and second thermocouple means and to hold the first holding element.

20. The sample carrier device according to claim 2, wherein the sample carrier unit comprises holding means for holding respective sample containers, which are designed to be capable of being set in a flexible manner, so that respective sample containers of a different size and of different materials can each be received individually by the sample carrier unit in a reversible manner.
